(19) United States
(12) Patent Application Publication
(10) Pub. No.: US 2026/0086369 A1
(43) Pub. Date: Mar. 26, 2026

(54) VIRTUAL IMAGE DISPLAY APPARATUS AND OPTICAL UNIT

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 19/332,051

(22) Filed: Sep. 18, 2025

(30) Foreign Application Priority Data
Sep. 20, 2024 (JP) 2024-163636

(51) Int. Cl. G02B 27/01

(52) U.S. Cl. CPC G02B 27/0172; G02B 2027/0118

(57) ABSTRACT

A virtual image display apparatus or an optical unit includes a display element, a first prism on which the image light is incident, a second prism joined to the first prism to constitute a prism-based light guide member having a parallel plate shape, an inclined mirror portion disposed at a joining portion between the first prism and the second prism and configured to reflect the image light, a lens having positive power and disposed so as to face an outer side surface of the first prism, and a transmissive mirror formed at an external side of the lens, the image light reflected by the inclined mirror portion, wherein the first prism has, at one of the outer side surface and an inner side surface facing the outer side surface in an upper portion, a ghost prevention structure configured to suppress propagation of the image light.

The present application is based on, and claims priority from JP Application Serial Number 2024-163636, filed Sep. 20, 2024, the disclosure of which is hereby incorporated by reference herein in its entirety.

### BACKGROUND

### 1. Technical Field

The present disclosure relates to a direct virtual image-type virtual image display apparatus and an optical unit that enable observation of a virtual image.

### 2. Related Art

As a head-mounted display apparatus, there is known to the public a head-mounted display apparatus including a liquid crystal image display panel, a first lens, a beam splitter, a concave mirror, a quarter-wave plate, and a second lens, wherein image light from the liquid crystal image display panel is incident on the beam splitter to be reflected by a beam splitting surface that reflects polarized light in a first polarization direction, then travels back and forth through the quarter-wave plate when being reflected by the concave mirror, and is transmitted through the beam splitter as polarized light in a second polarization direction (see JP-T-2003-502710). JP-T-2003-502710 is an example of the related art.

The head-mounted display apparatus described above has a configuration in which an intermediate image is not generated, and an optical diaphragm is not provided. Therefore, unnecessary light is confined in a light guide plate, which causes a problem that the unnecessary light reaches the eyes.

### SUMMARY

A virtual image display apparatus according to an aspect of the present disclosure includes a display element configured to emit image light, a first prism on which the image light from the display element is incident, a second prism joined to the first prism to constitute a prism-based light guide member having a parallel plate shape, an inclined mirror portion disposed at a joining portion between the first prism and the second prism and configured to reflect at least a part of the image light guided in the first prism, a lens having positive power and disposed so as to face an outer side surface of the first prism on which the image light reflected by the inclined mirror portion is incident, and a transmissive mirror formed at an external side of the lens and configured to partially reflect, toward the inclined mirror portion, the image light reflected by the inclined mirror portion, wherein the first prism has, at at least one of the outer side surface and an inner side surface facing the outer side surface in an upper portion, a ghost prevention structure configured to suppress propagation of the image light.

An optical unit according to an aspect of the present disclosure includes a display element configured to emit image light, a first prism on which the image light from the display element is incident, a second prism joined to the first prism to constitute a prism-based light guide member having a parallel plate shape, an inclined mirror portion disposed at a joining portion between the first prism and the second prism and configured to reflect at least a part of the image light guided in the first prism, a lens having positive power and disposed so as to face an outer side surface of the first prism on which the image light reflected by the inclined mirror portion is incident, and a transmissive mirror formed at an external side of the lens and configured to partially reflect, toward the inclined mirror portion, the image light reflected by the inclined mirror portion, wherein the first prism has, at one of the outer side surface and an inner side surface facing the outer side surface in an upper portion, a ghost prevention structure configured to suppress propagation of the image light.

### BRIEF DESCRIPTION OF THE DRAWINGS

FIG. 1 is an appearance diagram illustrating a use situation of a virtual image display apparatus according to a first embodiment.

FIG. 2 is a side cross-sectional view illustrating an internal structure of the virtual image display apparatus at one side.

FIG. 3 is a perspective view of the virtual image display apparatus.

FIG. 4 is a diagram illustrating optical paths and so on of the virtual image display apparatus shown in FIG. 2 and so on.

FIG. 5 is a conceptual diagram specifically illustrating unnecessary light incident on an upper portion of a first prism.

FIG. 6 illustrates an optical path of the unnecessary light incident on the upper portion of the first prism.

FIG. 7 is a diagram illustrating an optical path of other unnecessary light incident on the upper portion of the first prism.

FIG. 8 is a perspective view illustrating a modified example of the virtual image display apparatus shown in FIG. 3 and so on.

FIG. 9 is a diagram illustrating a projection state of unnecessary light in a virtual image display apparatus of a comparative example.

FIG. 10 is a diagram illustrating a projection state of unnecessary light in the virtual image display apparatus of a practical example.

FIG. 11 is a perspective view illustrating a virtual image display apparatus according to a second embodiment.

FIG. 12 is a diagram illustrating a projection state of unnecessary light in the virtual image display apparatus of a practical example.

FIG. 13 is a perspective view illustrating a virtual image display apparatus according to a third embodiment.

FIG. 14 is a diagram illustrating a projection state of unnecessary light in a virtual image display apparatus of a practical example.

FIG. 15 is a perspective view illustrating a virtual image display apparatus according to a fourth embodiment.

FIG. 16 is a perspective view illustrating a virtual image display apparatus according to a fifth embodiment.

FIG. 17 is a side cross-sectional view illustrating a virtual image display apparatus according to a modified example.

### DESCRIPTION OF EMBODIMENTS

### First Embodiment

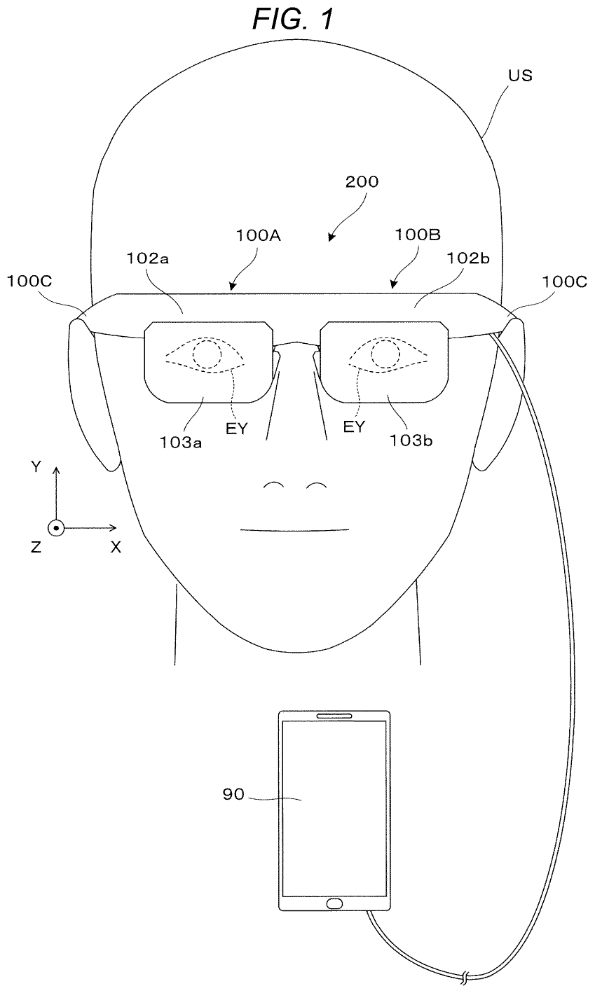

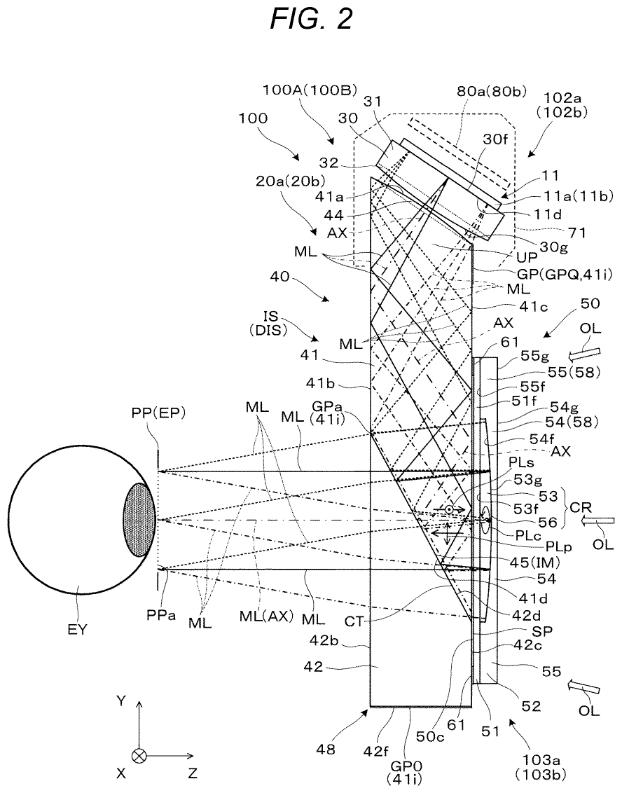

A first embodiment of a virtual image display apparatus and so on according to the present disclosure will hereinafter be described with reference to FIGS. 1, 2, and so on.

FIG. 1 is a diagram illustrating a state in which a head-mounted virtual image display apparatus (hereinafter also referred to as head-mounted display or HMD) 200 is mounted. The HMD 200 causes an observer or wearer US who wears the HMD 200 to recognize an image as a virtual image. In FIG. 1 and so on, the axes X, Y, and Z represent an orthogonal coordinate system. A +X direction corresponds to a lateral direction in which the two eyes EY of the observer or wearer US, who wears the HMD 200, are arranged. A +Y direction corresponds to an upward direction orthogonal to the lateral direction in which the two eyes EY are arranged for the wearer US. A +Z direction corresponds to a forward direction or a frontward direction for the wearer US. The Y directions are made parallel to a vertical axis or a vertical direction.

The HMD 200 includes a direct virtual image-type first virtual image display apparatus 100A for a right eye, a direct virtual image-type second virtual image display apparatus 100B for a left eye, a pair of temple-shaped support devices 100C for supporting the virtual image display apparatuses 100A, 100B, and a user terminal 90 as an information terminal. The first virtual image display apparatus 100A independently functions as an HMD, and includes a first display driver 102a disposed at an upper portion of the first virtual image display apparatus 100A and a first combiner 103a which is shaped like a spectacle lens and covers the front side of the eye. Similarly, the second virtual image display apparatus 100B independently functions as an HMD and includes a second display driver 102b disposed at an upper portion of the second virtual image display apparatus 100B and a second combiner 103b which is shaped like a spectacle lens and covers the front side of the eye. The pair of support devices 100C are a mounting member mounted on the head of the wearer US. The pair of support devices 100C support upper ends of the pair of combiners 103a, 103b via the display drivers 102a, 102b integrated with each other in appearance. The first virtual image display apparatus 100A and the second virtual image display apparatus 100B are optically the same or horizontally flipped.

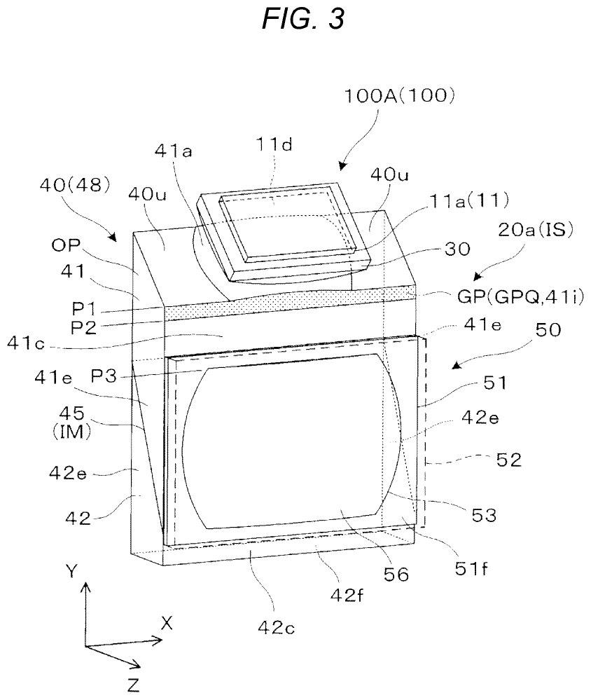

FIG. 2 is a side cross-sectional view illustrating an internal structure of the first virtual image display apparatus 100A. FIG. 3 is a perspective view of the first virtual image display apparatus 100A. The first virtual image display apparatus 100A includes a first image forming element 11a, a first display unit 20a, and a first circuit member 80a. The first image forming element 11a is also referred to as a display element 11. The first display unit 20a is an imaging optical system IS, which directly forms a virtual image without forming an intermediate image. The first display unit 20a is also referred to as a direct virtual image optical system DIS. The imaging optical system IS includes a first lens 30, a first flat-plate member 40, and a second flat-plate member 50. The first lens 30 has a function as a protective glass member that protects a display surface 11d of the display element 11. Note that a cover glass may be disposed between the display element 11 and the first lens 30. The first flat-plate member 40 guides image light ML output from the display element 11 to a second lens 53 of the second flat-plate member 50. The second flat-plate member 50 reflects the image light ML from the first flat-plate member 40 toward a pupil position PP or the eye EY so as to partially direct the image light ML back to the first flat-plate member 40, and causes external light OL to be incident on the pupil position PP via the first flat-plate member 40. The first lens 30, the first flat-plate member 40, and the second flat-plate member 50 each have a function as a lens having positive refractive power.

Although not described in detail, the second virtual image display apparatus 100B includes a second image forming element 11b, a second display unit 20b, and a second circuit member 80b. The second image forming element 11b is substantially the same as the first image forming element 11a. The second display unit 20b is substantially the same as the first display unit 20a. The second circuit member 80b is substantially the same as the first circuit member 80a.

In the first virtual image display apparatus 100A, the first image forming element 11a is a self-luminous image light generator. The first image forming element 11a outputs the image light ML to the first flat-plate member 40 via the first lens 30. The first image forming element 11a is housed in and supported by an enclosure 71. The first image forming element 11a is, for example, an organic electro-luminescence (EL) display. The first image forming element 11a forms a color still image or a color moving image on the display surface 11d as a two-dimensional surface. The first image forming element 11a is driven by the first circuit member 80a to perform a display operation. The first image forming element 11a is not limited to an organic EL display, and can be replaced with a display device using inorganic EL, an organic LED, an LED array, a laser array, a quantum dot luminous element, or the like. The first image forming element 11a is not limited to a self-luminous image light generator, and may be a device which is configured with a light modulation element such as an LCD and forms an image by illuminating the light modulation element with a light source such as a backlight. As the first image forming element 11a, a liquid crystal on silicon (LCOS, LCOS is a registered trademark) or the like can be used in place of the LCD. Note that an optical apparatus obtained by excluding the first circuit member 80a from the first virtual image display apparatus 100A is referred to as an optical unit 100. It can be said that the optical unit 100 is a portion which includes a direct virtual image-type optical system and corresponds to a direct virtual image optical system DIS constituting the first virtual image display apparatus 100A.

The first display unit 20a includes the first lens 30, the first flat-plate member 40, an inclined mirror portion IM, and the second flat-plate member 50. In the first display unit 20a, the first lens 30 has positive refractive power, and the image light ML from the first image forming element 11a enters the first lens 30. The first lens 30 has a plane of incidence of light 30f as a flat surface to be bonded to the first image forming element 11a, and a light exit surface 30g as a convex surface. The light exit surface 30g is, for example, a spherical surface, and may be an aspherical surface having an axisymmetric shape. The first lens 30 can be conceptually divided into a parallel flat plate 31 and a lens portion 32. Foreign matter having adhered to the surface of the first lens 30 becomes inconspicuous by ensuring the thickness of the parallel flat plate 31 no smaller than a predetermined value. The parallel flat plate 31 has a function as a cover glass. The lens portion 32 is a planoconvex lens having positive refractive power. One surface of the planoconvex lens has a planar shape, and the other surface thereof has a convex shape. Note that the parallel flat plate 31 and the lens portion 32 may be bonded to each other or may be separated from each other. The lens portion 32 is not required to be a planoconvex lens, and may be, for example, a biconvex lens. Further, the first lens 30 is made of, for example, fused quartz and has a relatively low refractive index.

The first flat-plate member 40 includes a first prism 41 shaped like a parallel flat plate and a second prism 42 shaped like a parallel flat plate. The first prism 41 and the second prism 42 are bonded to each other at inclined surfaces 41d, 42d. What is obtained by bonding the first prism 41 and the second prism 42 to each other is referred to as a prism-based light guide member 48. The prism-based light guide member 48 has an appearance of a parallel flat plate. The inclined mirror portion IM, which is a planar surface, is formed at the first inclined surface 41d formed at a lower side of the first prism 41. What is obtained by combining the prism-based light guide member 48 and the second flat-plate member 50 described later corresponds to the first combiner 103a.

The first prism 41 has a quadrangular prismatic outer shape and has a trapezoidal longitudinal cross-section. The first prism 41 is for guiding the image light ML. The first prism 41 has an optical plane of incidence 41a, a first inner side surface 41b, a first outer side surface 41c, and the first inclined surface 41d. Further, the first prism 41 further has an upper planar surface 40u and first lateral side surfaces 41e (see FIG. 3). Here, the optical plane of incidence 41a inclines downward on the front side thereof as a whole, and an optical axis passing through the optical plane of incidence 41a extends in a direction between the +Z direction as a frontward direction, and the +Y direction as an upward direction. Thus, it becomes easy to dispose the first image forming element 11a as the display element 11 at an external side of the first inner side surface 41b, and thus, it is possible to adjust an angle at which the image light ML is made to propagate in the first prism 41 (in the first prism 41 or through the inside of the first prism 41). The optical plane of incidence 41a is a convex surface such as a spherical surface, and may instead be an axisymmetric aspherical surface. It is conceivable that the first prism 41 is provided with a lens portion 44 having the optical plane of incidence 41a. The lens portion 44 is a planoconvex lens having positive refractive power. The lens portion 44 may be directly formed as a part of the first prism 41 or may be bonded to the first prism 41. The first inner side surface 41b and the first outer side surface 41c are parallel to each other and extend in a direction perpendicular to an optical axis AX between the pupil position PP, and the first inner side surface 41b and the first outer side surface 41c. The first inner side surface 41b and the first outer side surface 41c are for internally reflecting the image light ML (i.e., reflecting the image light ML at inner side of an object surface), and are particularly preferable for totally reflecting the image light ML. The scratch resistance or scuff resistance of the first inner side surface 41b can be enhanced by being provided with a hard coat. The first inclined surface 41d is a planar surface. The first inclined surface 41d is at an acute angle with the first outer side surface 41c, specifically an angle in a range from 25° to 32°. Note that a distance between the optical axis AX passing through the pupil position PP and an upper end of the first lens 30 is about 20 mm. The first prism 41 is made of a resin material.

The number of times of reflection of the image light ML in the first prism 41 is one at the first inner side surface 41b, one at the first outer side surface 41c, and further, one at the inclined mirror portion IM described later. By setting the number of times of internal reflection of the image light ML in the first prism 41 to two, it is possible to efficiently avoid mixture of light different in number of times of reflection in the first prism 41 while increasing a field angle of the image light ML, and the pupil position PP or an aperture PPa at the pupil position PP. In addition, it becomes easy to shorten the distance from the display element 11 to a transmissive mirror 56 of a cover member 52 described later, and thus, the prism-based light guide member 48 can be reduced in size, and it is also easy to reduce the sizes of the display element 11 and the first lens 30.

Similarly to the first prism 41, the second prism 42 has a quadrangular prismatic outer shape and has a trapezoidal longitudinal cross-section. The second prism 42 is for transmitting the image light ML. The second prism 42 has a second inner side surface 42b, a second outer side surface 42c, the second inclined surface 42d, and a first bottom surface 42f. The first bottom surface 42f is a surface opposed to the optical plane of incidence 41a at an opposite side in the prism-based light guide member 48 or the first flat-plate member 40. Further, the first bottom surface 42f is a surface opposed to the second inclined surface 42d at an opposite side in the second prism 42. Further, the second prism 42 has second lateral side surfaces 42e (see FIG. 3). Here, the second inner side surface 42b and the second outer side surface 42c are parallel to each other, and extend in a direction perpendicular to the optical axis AX between the pupil position PP and the second inner side surface 42b and the second outer side surface 42c. The scratch resistance of the second inner side surface 42b can be enhanced by being provided with a hard coat. The second prism 42 is made of a resin material.

In the first prism 41 of the first flat-plate member 40, there is a possibility that the optical plane of incidence 41a, the first inner side surface 41b, and the first outer side surface 41c cause stray light due to the image light ML. That is, since the first virtual image display apparatus 100A or the optical unit 100 is the direct virtual image optical system DIS, it is not possible to provide an aperture stop, and there is a relatively high possibility that the image light ML travels around to an unintended optical path to reach the pupil position PP, and is observed as a ghost. In the present embodiment, although details will be described later, a light absorption-type ghost prevention structure GPQ, specifically, a light absorption layer 41i, that blocks, by absorption, the image light ML to be a factor of the stray light is disposed at the first outer side surface 41c as a ghost prevention structure GP in an upper portion UP of the first prism 41. The ghost prevention structure GP can be referred to as an image light ghost prevention structure from the viewpoint of limiting passage of the stray light caused by the image light ML, and can be referred to as an in-light guide ghost prevention structure from the viewpoint of limiting passage of the stray light propagating in the prism-based light guide member 48.

The light absorption layer 41i as the light absorption-type ghost prevention structure GPQ is formed in the upper portion UP of the first prism 41, more specifically, in an upper end region of the first outer side surface 41c of the first prism 41, as a band-shaped region elongated in the lateral X direction. The light absorption layer 41i is formed in a region from an upper end position P1 to a lower end position P2 at a lower side of the first outer side surface 41c of the first prism 41. In the illustrated example, the lower end position P2 is made higher than an upper end position P3 of the second lens 53. The light absorption layer 41i illustrated in the drawing is illustrative only, and the vertical width of the light absorption layer 41i is determined by estimating the optical path of the unintended image light ML incident on the upper portion UP of the first prism 41 or an effective region thereof by a simulation or the like. The shape of a lower end of the light absorption layer 41i is not limited to a linear shape, and may be a curved shape.

The light absorption layer 41i is a black matte coating used for optical applications. The light absorption layer 41i is formed in a desired region on the first outer side surface 41c by, for example, applying and then drying a liquid material provided with light absorption properties by mixing a black pigment, a resin material, a solvent, and so on. The light absorption layer 41i absorbs the image light ML incident thereon with high efficiency to suppress scattering of the image light ML.

The light absorption layer 41i is not limited to what completely absorbs the image light ML, and may be what partially transmits the image light ML. In addition, the light absorption layer 41i may be a black dot pattern formed of dots of an absorption material. However, it is desirable for the light absorption layer 41i to be able to cut the image light ML by at least half or more, preferably no less than 80%. The light absorption layer 41i may be achieved by an absorption type or reflection type polarizing plate, preferably an absorption type polarizing plate. On this occasion, the polarization direction of the polarizing plate is desirably orthogonal to the polarization direction of a polarization separation film 45 described later, and is set to block, for example, s-polarized light.

As shown in FIG. 2, the light absorption layer 41i is also disposed as a ghost prevention structure GP0 at the first bottom surface 42f of the prism-based light guide member 48. The light absorption layer 41i can also prevent the image light ML passing through the inclined mirror portion IM and the external light OL entering the inside from the second prism 42 from causing the stray light.

In the prism-based light guide member 48, the light absorption layer 41i is disposed as a ghost prevention structure GPa in a narrow region at an upper end of the inclined surface 41d of the first prism 41. The light absorption layer 41i of the ghost prevention structure GPa is formed in a linear region extremely narrow in a vertical direction or the Y direction to the extent that the field of view is not hindered. The light absorption layer 411 can also prevent the image light ML incident on an upper end of the polarization separation film 45 from causing the stray light.

The inclined mirror portion IM reflects at least a part of the image light ML guided in the first prism 41. The inclined mirror portion IM is integrally formed at the first inclined surface 41d of the first prism 41 to be sandwiched between the first inclined surface 41d of the first prism 41 and the second inclined surface 42d of the second prism 42. A space between the inclined mirror portion IM and the second inclined surface 42d is filled with an adhesive CT for bonding purposes. The bonding of the inclined mirror portion IM and the second inclined surface 42d is not limited to bonding with the adhesive CT, but may be bonding with an adhesive film or the like. In the present embodiment, the inclined mirror portion IM is the polarization separation film 45. The polarization separation film 45 is, for example, a polarization beam splitter having a characteristic of reflecting s-polarized light. The polarization separation film 45 is configured with, for example, a dielectric multilayer film, efficiently reflects the image light ML as s-polarized light PLs when the image light ML contains the s-polarized light PLs, and efficiently transmits the image light ML as p-polarized light PLp when the image light ML contains the p-polarized light PLp. The polarization separation film 45 may be any film as long as that film selectively reflects the image light ML in accordance with the polarization direction thereof, and may be, for example, a multilayer film, a wire grid polarizer such as a wire grid film, or a reflective polarization element using film stretching.

Note that the polarization separation film 45 may be what transmits the s-polarized light PLs and reflects the p-polarized light PLp.

The inclined mirror portion IM is only required to have a surface that is flat enough not to affect the image formation. Further, the inclined mirror portion IM may have a minute convexly or concavely curved surface to the extent that the image formation is not affected. Note that a space between the inclined mirror portion IM and the first inclined surface 41d may be filled with a filler having a light transmissive property in place of the adhesive CT. In this case, the first prism 41 and the second prism 42 may be supported by a support member or the like from outside to maintain the bonded state. Further, the inclined mirror portion IM may integrally be formed at the second inclined surface 42d of the second prism 42 instead of the first inclined surface 41d of the first prism 41. The scratch resistance or scuff resistance of the inclined mirror portion IM can be enhanced by providing the surface thereof with a hard coat.

The second flat-plate member 50 includes a quarter-wave plate 51 shaped like a thin plate, and the cover member 52. The quarter-wave plate 51 is formed of a crystal, a liquid crystal material, or the like having an optical axis between the X direction and the Y direction. The quarter-wave plate 51 converts the image light ML as the s-polarized light PLs reflected by the polarization separation film 45 into circularly polarized light PLC, and converts the image light ML as the circularly polarized light PLc reflected by the cover member 52 into the p-polarized light PLp. The cover member 52 includes the second lens 53 as a planoconvex lens, a compensation lens 54 as a planoconcave lens, a compensation flat plate 55 disposed on the periphery of the compensation lens 54 and extending in parallel to the prism-based light guide member 48, and a transmissive mirror 56. Note that in the illustrated example, the second flat-plate member 50 is formed in a narrower area than the first flat-plate member 40, but may be formed in a comparable area with the first flat-plate member 40.

The second flat-plate member 50 is disposed at a distance in a range from about 20 μm to 50 μm from the first flat-plate member 40. There is a possibility that the first outer side surface 41c and the second outer side surface 42c of the first flat-plate member 40 and a third inner side surface 50c of the second flat-plate member 50 is slightly curved, so that a minute step is formed on the boundary between the first outer side surface 41c and the second outer side surface 42c, but it is possible to prevent these surfaces from coming excessively close to each other by setting the distance between the first and second outer side surfaces 41c, 42c and the third inner side surface 50c to no less than 20 μm, more preferably, no less than 30 μm. Conversely, by setting the distance between the first and second outer side surfaces 41c, 42c and the third inner side surface 50c to no more than 50 μm, it is possible to prevent the thickness of the first combiner 103a having the first flat-plate member 40 and the second flat-plate member 50 combined with each other from increasing. A spacer 61 for adjusting the distance between the first flat-plate member 40 and the second flat-plate member 50 and fixing the first flat-plate member 40 and the second flat-plate member 50 in a state in which the first flat-plate member 40 and the second flat-plate member 50 are positioned with each other is disposed between the first and second outer side surfaces 41c, 42c of the first flat-plate member 40 and the third inner side surface 50c of the second flat-plate member 50. The spacer 61 is not provided over the entire circumference of the second flat-plate member 50. That is, a gap SP between the first flat-plate member 40 and the second flat-plate member 50 is not sealed but communicates with the outside.

In the cover member 52, the second lens 53 is disposed so as to face the first outer side surface 41c to condense the image light ML. The second lens 53 is a planoconvex lens that is thin but has positive refractive power. One surface of the planoconvex lens has a planar shape, and the other surface thereof has a shape convex outward. The second lens 53 has a planar surface 53f bonded to the quarter-wave plate 51 and a convex surface 53g facing the compensation lens 54. The convex surface 53g is, for example, a spherical surface, and may be an axisymmetric aspherical surface. The compensation lens 54 is thin but has positive refractive power. The compensation lens 54 has a concave surface 54f facing the second lens 53, and a planar surface 54g. The compensation flat plate 55 is a parallel flat plate. The compensation flat plate 55 has a pair of planar surfaces 55f, 55g. Here, the concave surface 54f of the compensation lens 54 has the same shape as the shape of the convex surface 53g of the second lens 53. The planar surface 54g of the compensation lens 54 and the planar surface 55g of the compensation flat plate 55 are coplanar with each other and are continuous with each other. The transmissive mirror 56 is a thin film formed on the convex surface 53g of the second lens 53, and has the same shape as the shape of the convex surface 53g. A combination of the second lens 53 and the transmissive mirror 56 is referred to as a light collecting reflector CR.

The second lens 53, the compensation lens 54, and the compensation flat plate 55 are made of a resin material and have the same refractive index. The refractive index of the second lens 53 and so on is lower than the refractive index of the first prism 41. The compensation lens 54 and the compensation flat plate 55 are integrally formed of the same resin material into an optical element 58.

A combination of the second lens 53, the compensation lens 54, and the compensation flat plate 55 functions as a parallel flat plate as a whole. That is, the external light OL incident on the surfaces of the compensation lens 54 and the compensation flat plate 55 passes through the compensation lens 54 and the compensation flat plate 55 without being affected by the lens effects provided by the compensation lens 54 and so on and the step located at an outer edge of the compensation lens 54. In this way, the compensation lens 54 optically compensates for the influence of the second lens 53 on the external light OL. In this sense, the planar surface 53f of the second lens 53, the planar surface 54g of the compensation lens 54, and the planar surfaces 55fa, 55g of the compensation flat plate 55 are each not necessarily limited to a planar surface in an exact sense, and may each be, for example, a substantially planar surface or may each partially or entirely include a curved surface. In addition, the planar surface 53f of the second lens 53, the planar surface 54g of the compensation lens 54, and the planar surfaces 55f, 55g of the compensation flat plate 55 may each include a curved surface for correcting the eyesight of the wearer US or a curved surface for a good appearance such as that of sunglasses or non-prescribed glasses to the extent that no inconvenience occurs in terms of optical performance. The planar surfaces 54g, 55g of the compensation lens 54 and the compensation flat plate 55 may each be provided with an antireflection film or a hard coat. The external light OL passing through the compensation flat plate 55 passes through a portion around the compensation lens 54. The external light OL is incident on a peripheral region outside the region on which the image light ML is incident and which corresponds to the compensation lens 54, that is, incident on the compensation flat plate 55. Thus, a wide see-through visual field with respect to the outside can be ensured. The visual field range of the external light OL is set to, for example, about 40° in the upward direction and about 40° in the downward direction.

The transmissive mirror 56 is a half mirror. The transmissive mirror 56 partially reflects the image light ML having passed through the second lens 53 and partially transmits the external light OL. The transmissive mirror 56 reflects, toward the pupil position PP, the image light ML which has been reflected by the inclined mirror portion IM of the first flat-plate member 40 or the polarization separation film 45 and passed through the quarter-wave plate 51 and the second lens 53. The transmissive mirror 56 is a concave mirror that covers the pupil position PP, at which the eye EY or the pupil thereof is disposed, and has a concave shape toward the pupil position PP and a convex shape toward the outside. The pupil position PP or the aperture PPa at the pupil position PP is called an eye point or an eye box, and corresponds to an exit pupil EP of the first display unit 20a.

The transmissive mirror 56 transmits part of the external light OL, and therefore allows see-through viewing of the outside, and can superimpose a virtual image on an external image. On this occasion, the external light OL passes through the first flat-plate member 40 and the second flat-plate member 50, but the flat-plate members 40, 50 do not cause a lens function in the external light OL. The reflectance of the transmissive mirror 56 for the image light ML and the external light OL is set to a value no less than 10% and no more than 50% over an assumed incident angle of the image light ML from the viewpoint of ensuring the luminance of the image light ML and facilitating the observation of the external image due to the see-through viewing. The transmissive mirror 56 is formed of, for example, a dielectric multilayer film configured with a plurality of dielectric layers each having an adjusted film thickness. The transmissive mirror 56 may be a monolayer or multilayer film made of metal such as Al or Ag and having an adjusted film thickness. The transmissive mirror 56 is formed by, for example, evaporation-based lamination.

In the first virtual image display apparatus 100A, the first lens 30, the lens portion 44, the second lens 53, and the transmissive mirror 56 each have positive refractive power and tend to cause divergent light to converge. The first lens 30, the lens portion 44, the second lens 53, and the transmissive mirror 56, including the body of the first prism 41, the second prism 42, and the like, function as the imaging optical system IS or the direct virtual image optical system DIS such as that of a monocular microscope that forms an erect image. Thus, it is possible to form a virtual image obtained by projecting a real image formed on the display surface 11d of the first image forming element 11a at infinity, or a virtual image obtained by projecting the real image formed on the display surface 11d at a point several meters ahead. On this occasion, the refractive power of each of the first lens 30, the lens portion 44, the second lens 53, and the transmissive mirror 56 is adjusted to shorten the focal length of the imaging optical system IS, so that a desired magnification factor can be achieved.

The size in a longitudinal direction of the first flat-plate member 40 or the second flat-plate member 50 is, for example, 34 mm, and the size thereof in a transverse direction is, for example, 40 mm. The thickness of the first flat-plate member 40 in a front-back direction is in a range of, for example, from about 7 mm to 8 mm, and the total thickness of the first flat-plate member 40 and the second flat-plate member 50 is suppressed to a value in a range from about 7.5 mm to 8.5 mm.

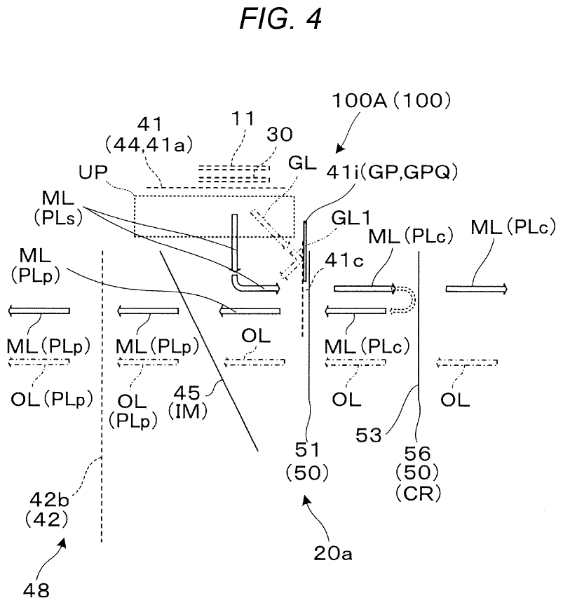

FIG. 4 illustrates the optical path and so on of the first virtual image display apparatus 100A. As shown in FIG. 4, the image light ML from the first image forming element 11a enters the first prism 41 via the first lens 30. On this occasion, the degree of divergence of the image light ML is suppressed by the positive refractive power of the first lens 30 and the lens portion 44. In the optical path passing through the first prism 41, the image light ML is sequentially reflected by the first inner side surface 41b of the first prism 41 and the first outer side surface 41c of the first prism 41 without forming an intermediate image (see FIG. 2), and the s-polarized light PLs in the image light ML is reflected by the polarization separation film 45. The image light ML as the s-polarized light PLs reflected by the polarization separation film 45 is transmitted through the first outer side surface 41c of the first prism 41, and then passes through the quarter-wave plate 51 of the second flat-plate member 50 to thereby be converted into the circularly polarized light PLC, and enters the second lens 53 and the transmissive mirror 56. A part of the image light ML as the circularly polarized light PLc incident on the transmissive mirror 56 is reflected by the transmissive mirror 56, and then passes through the quarter-wave plate 51 once again in a state of being collimated through the second lens 53. Thus, the image light ML having passed through the quarter-wave plate 51 turns to the p-polarized light PLp, enters the first prism 41 via the first outer side surface 41c, then is transmitted through the polarization separation film 45, and is then emitted to the outside of the second prism 42 via the second inner side surface 42b. The image light ML having been emitted to the outside of the second prism 42 is incident on the pupil position PP where the eye EY or the pupil of the wearer US is disposed (see FIG. 2). Not only the image light ML having been reflected by the transmissive mirror 56 but also the external light OL having passed through the transmissive mirror 56, and the external light OL having passed through the compensation flat plate 55 are incident on the pupil position PP. That is, the wearer US who wears the first virtual image display apparatus 100A can observe a virtual image with the image light ML superimposed on the external image.

In the present embodiment, unnecessary light GL which is the ghost light caused by the image light ML is incident on the upper portion UP of the first prism 41 through an unintended optical path, and is incident on the first outer side surface 41c at an unexpected location. When the ghost prevention structure GP is not provided at the first outer side surface 41c, the unnecessary light GL1 incident on the first outer side surface 41c is reflected by the first outer side surface 41c, guided in the prism-based light guide member 48, and reaches the eye EY of the wearer US. As a result, the ghost caused by the unnecessary light GL1 is reflected in the visual field, that is, the ghost image is projected adjacent to or superimposed on the virtual image to be originally observed, which hinders observation of the virtual image. On the other hand, when the ghost prevention structure GP is provided at the first outer side surface 41c, the unnecessary light GL incident on the first outer side surface 41c is efficiently absorbed by the light absorption layer 41i of the ghost prevention structure GP, does not reach the eye EY of the wearer US, and does not become a ghost. Accordingly, the wearer US can observe the virtual image in a state where there is no ghost in the visual field.

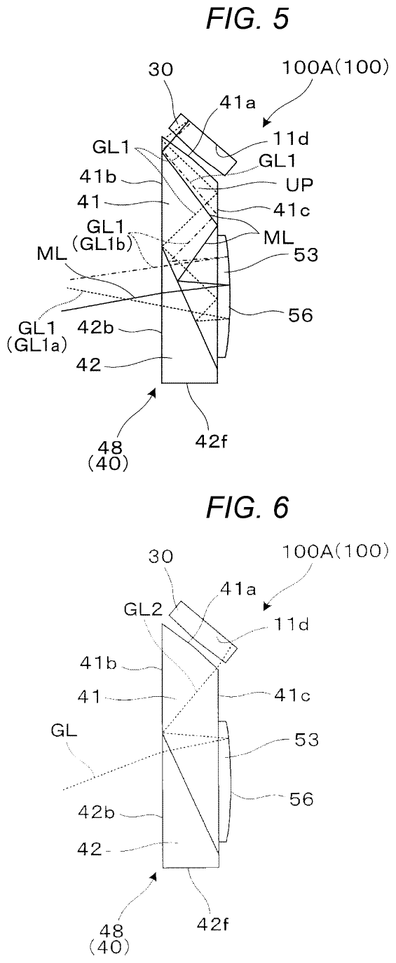

FIG. 5 is a conceptual diagram specifically illustrating the unnecessary light GL1 caused by the image light ML incident on the upper portion UP of the first prism 41 from an unintended optical path. In this case, unnecessary light GL1a, which is a specific component of the unnecessary light GL1, is sequentially reflected by the first inner side surface 41b and the first outer side surface 41c at an unexpected location in the upper portion UP of the first prism 41. As a result, the unnecessary light GL1a is reflected twice by each of the first inner side surface 41b and the first outer side surface 41c in the first prism 41, passes through the inclined mirror portion IM and the transmissive mirror 56, and is incident on the pupil position PP at an angle of about 17° from the obliquely downward direction together with the image light ML from the normal optical path. The unnecessary light GL1 forms a ghost image outside the image region of the virtual image and below the image region. Unnecessary light GL1b, which is another component of the unnecessary light GL1, is sequentially reflected by the first inner side surface 41b and the first outer side surface 41c at an unexpected location in the upper portion UP of the first prism 41. The unnecessary light GL1b is incident on the pupil position PP at an angle of about 20° from the obliquely upward direction together with the image light ML from the normal optical path via the inclined mirror portion IM and the transmissive mirror 56. The unnecessary light GL1b forms a ghost image outside the image region of the virtual image and below the image region. However, the passage of such unnecessary light GL1, that is, the unnecessary light GL1a, GL1b is restricted by the ghost prevention structure GP illustrated in FIG. 3, and the observation of the ghost is suppressed.

FIG. 6 illustrates an optical path of unnecessary light GL2 caused by other image light ML incident on the optical plane of incidence 41a of the first prism 41 from an unintended optical path. In this case, the unnecessary light GL2 is reflected by an upper end of the inclined mirror portion IM on the boundary between the first prism 41 and the second prism 42 to deviate from the optical path, passes through the transmissive mirror 56 and so on, and is incident on the pupil position PP at an angle of about 20° from the obliquely upward direction. The unnecessary light GL2 forms a ghost image outside the image region of the virtual image and above the image region. However, passage of such unnecessary light GL2 is restricted by the ghost prevention structure GPa illustrated in FIG. 2, and the observation of the ghost is suppressed.

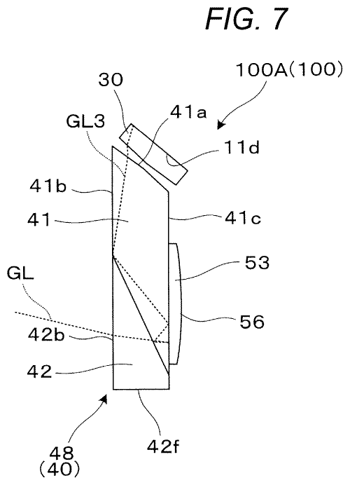

FIG. 7 illustrates an optical path of unnecessary light GL3 caused by still other image light ML incident on the optical plane of incidence 41a of the first prism 41 from an unintended optical path. In this case, the unnecessary light GL3 is sequentially reflected by the first inner side surface 41b and the first outer side surface 41c, is reflected by the first outer side surface 41c without being incident on the transmissive mirror 56 via the inclined mirror portion IM, and is incident on the pupil position PP at an angle of about 13° from an obliquely downward direction. The unnecessary light GL3 forms a ghost image outside the image region of the virtual image and below the image region. However, passage of such unnecessary light GL3 is restricted by the ghost prevention structure GPa illustrated in FIG. 2, and the observation of the ghost is suppressed.

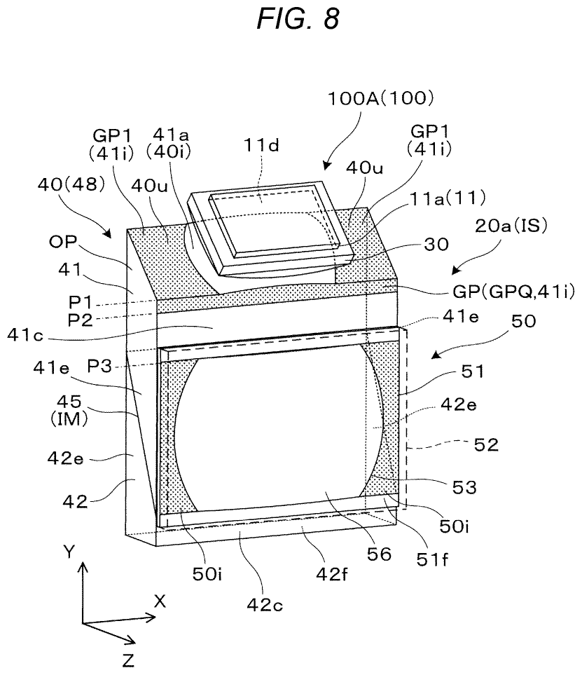

FIG. 8 is a perspective view illustrating a modified example of the first virtual image display apparatus 100A or the optical unit 100 illustrated in FIG. 3 and so on. In this case, in the first prism 41, the light absorption layer 41i is provided as the ghost prevention structure GP1 at the upper planar surface 40u. Due to the ghost prevention structure GP1, it is possible to prevent the image light ML from entering an unintended optical path and reaching the pupil position PP to be observed as a ghost. Note that the upper planar surface 40u of the first prism 41 corresponds to a peripheral region of the optical plane of incidence 41a which is a plane of incidence 40i of the first prism 41.

The light absorption layer 41i has a contour corresponding to the upper planar surface 40u, but is not limited thereto, and for example, may cover the vicinity of the optical plane of incidence 41a and expose the upper planar surface 40u in a region close to the lateral side surfaces 41e and 42e.

Although not essential, a light absorption layer 50i may be disposed at surfaces of outer circumferential portions 51f at left and right sides of the quarter-wave plate 51 or the planar surface 55f at the back side of the compensation flat plate 55 corresponding to the outer circumferential portions 51f. The light absorption layer 50i targets the image light ML emitted from the prism-based light guide member 48 through, for example, the inclined mirror portion IM and incident on the vicinity of the outside of the second lens 53 and the external light OL, and prevents such unnecessary light from causing a ghost.

Referring to FIG. 2, the light absorption layer 41i is also provided as the ghost prevention structure GP0 at the first bottom surface 42f of the prism-based light guide member 48.

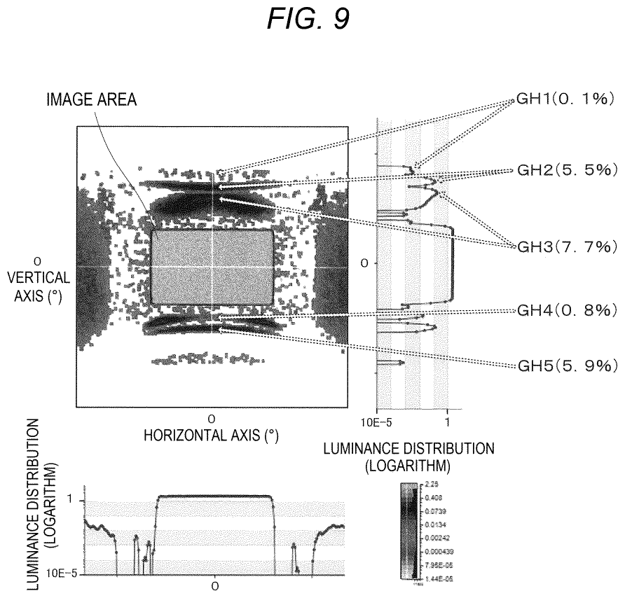

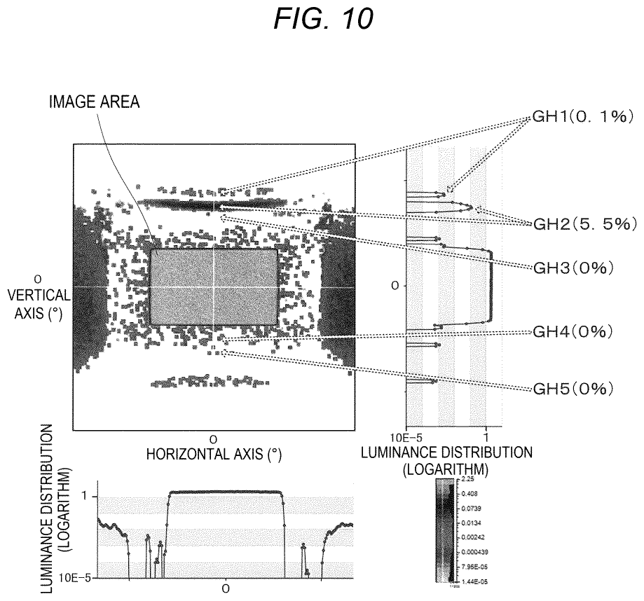

FIG. 9 is a diagram illustrating a projection state of unnecessary light in a virtual image display apparatus of a comparative example, and FIG. 10 is a diagram illustrating a projection state of unnecessary light in a virtual image display apparatus of a practical example related to the first embodiment. FIG. 9 illustrates when the main ghost prevention structure GP, that is, the light absorption-type ghost prevention structure GPQ, is removed from the first virtual image display apparatus 100A or the optical unit 100 illustrated in FIG. 8, and FIG. 10 illustrates when the ghost prevention structure GP, that is, the light absorption-type ghost prevention structure GPQ, is left unchanged from the configuration illustrated in FIG. 8.

In FIGS. 9 and 10, a simulation image showing a detection state by the angle light receiver arranged at the pupil position PP when an all-white image is displayed on the display element 11 is shown in an upper left region, a graph showing a logarithmic display of a luminance distribution on a vertical axis line at the center at an angle of 0° on an H axis (horizontal axis) is shown at the right side of the simulation image, and a graph showing a logarithmic display of a luminance distribution on horizontal axis line at the center at an angle of 0° on a V axis (vertical axis) is shown at the lower side of the simulation image. The angle light receiver assumed in the simulation evaluates the observation image in the entire eye box set at the pupil position PP. Each numerical value shown in the luminance distribution in the H axis and the V axis represents a rate of the unnecessary light when the luminance of the image region viewed at the center of the screen of the simulation image is set to 100%.

As illustrated in FIG. 9, in the virtual image display apparatus of the related art example, ghosts due to a large amount of unnecessary light occur outside the image region, and it is understood that the virtual image display apparatus is not suitable for an application such as image viewing. Five types of ghosts GH1, GH2, GH3, GH4, and GH5 are formed above and below the outside of the image region. The first-type ghost GH1 is formed at the upper side of the image region at a distance of about a half field angle in the vertical direction, the second-type ghost GH2 is formed near the lower side of the first-type ghost GH1, and the third-type ghost GH3 is formed near the lower side of the second-type ghost GH2. That is, the second-type ghost GH2 is formed between the first-type ghost GH1 and the third-type ghost GH3. The fourth-type ghost GH4 is formed at the lower side of the image region at a distance from the image region, and the fifth-type ghost GH5 is formed near the lower side of the fourth-type ghost GH4. The first-type ghost GH1 has a luminance of about 0.1% compared to the central image region, the second-type ghost GH2 has a luminance of about 5.5% compared to the central image region, and the third-type ghost GH3 has a luminance of about 7.7% compared to the central image region. The fourth-type ghost GH4 has a luminance of about 0.8% compared to the central image region, and the fifth-type ghost GH5 has a luminance of about 5.9% compared to the central image region.

As illustrated in FIG. 10, in the virtual image display apparatus of the practical example, it is understood that the luminance of the third-type ghost GH3, the fourth-type ghost GH4, and the fifth-type ghost GH5 is reduced by the light absorption layer 41i as the ghost prevention structure GP. The luminance of the third-type ghost GH3 decreases from 7.7% in the comparative example to about 0%. The luminance of the fourth-type ghost GH4 decreases from 0.8% in the comparative example to about 0%. The luminance of the fifth-type ghost GH5 also decreases from 5.9% in the comparative example to about 0%.

An example of the structure and assembly of the first display unit 20a constituting the first virtual image display apparatus 100A will be described. The first prism 41 and the second prism 42 are prepared. In an upper end region of the first inner side surface 41b of the first prism 41, a liquid material provided with a light-absorbing property is applied and then dried to thereby form the light absorption layer 41i. The polarization separation film 45 as the inclined mirror portion IM is formed on the first inclined surface 41d of the first prism 41 by various methods such as attaching a sheet-like reflective polarizing film made of a resin multilayer film or wire grid polarizing film, or forming a dielectric multilayer film by vacuum deposition. Subsequently, the first prism 41 and the second prism 42 are joined at the inclined surfaces 41d, 42d to obtain the prism-based light guide member 48 or the first flat-plate member 40. In parallel with this, a unit obtained by integrally joining the quarter-wave plate 51, the second lens 53 provided with the transmissive mirror 56, and the optical element 58 is prepared, and this unit is attached to the outer side surfaces 41c and 42c of the first flat-plate member 40 so as to be opposed thereto. On this occasion, the spacer 61 as a pair of thin adhesives is disposed between the outer side surfaces 41c, 42c of the first flat-plate member 40 and the quarter-wave plate 51, and thus, the gap SP is formed between the outer side surfaces 41c, 42c of the first flat-plate member 40 and the quarter-wave plate 51.

The inclined mirror portion IM is not limited to the polarization separation film 45 and may be a transmissive mirror. In this case, the quarter-wave plate 51 can be omitted.

The virtual image display apparatuses 100A, 100B or the optical unit 100 according to the first embodiment described hereinabove includes the display element 11 configured to output the image light ML, the first prism 41 on which the image light ML from the display element 11 is incident, a second prism 42 which is bonded to first prism 41 to constitute the prism-based light guide member 48 having a parallel flat plate shape, the inclined mirror portion IM which is disposed at the position where the first prism 41 and the second prism 42 are bonded to each other and reflects at least part of the image light ML guided in the first prism 41, the second lens 53 having a planoconvex shape and disposed so as to face the first outer side surface 41c of the first prism on which the image light ML having been reflected by the inclined mirror portion IM is incident, and the transmissive mirror 56 which is formed at the convex surface 53g of the second lens 53 and partially reflects, toward the inclined mirror portion IM, the image light ML reflected by the inclined mirror portion IM, and the first prism 41 includes the ghost prevention structure GP for preventing the propagation of the image light ML at one of the first outer side surface 41c and the first inner side surface 41b opposed thereto in the upper portion UP.

In the virtual image display apparatuses 100A and 100B or the optical unit 100 described above, since the first prism 41 has the ghost prevention structure GP that suppresses the propagation of the image light ML at one of the first outer side surface 41c and the first inner side surface 41b in the upper portion UP, even when the unnecessary light GL1 or the like which is an unintended component of the image light ML is incident on the upper portion UP of the first prism 41, the passage thereof is limited by the ghost prevention structure GP, and it is possible to suppress the observation of the ghost in the periphery or the like of the virtual image which is the observation target.

### Second Embodiment

A virtual image display apparatus and so on according to a second embodiment will hereinafter be described. Note that the virtual image display apparatus according to the second embodiment is obtained by partially changing the virtual image display apparatus according to the first embodiment, and the description of portions common to those of the virtual image display apparatus according to the first embodiment will be omitted.

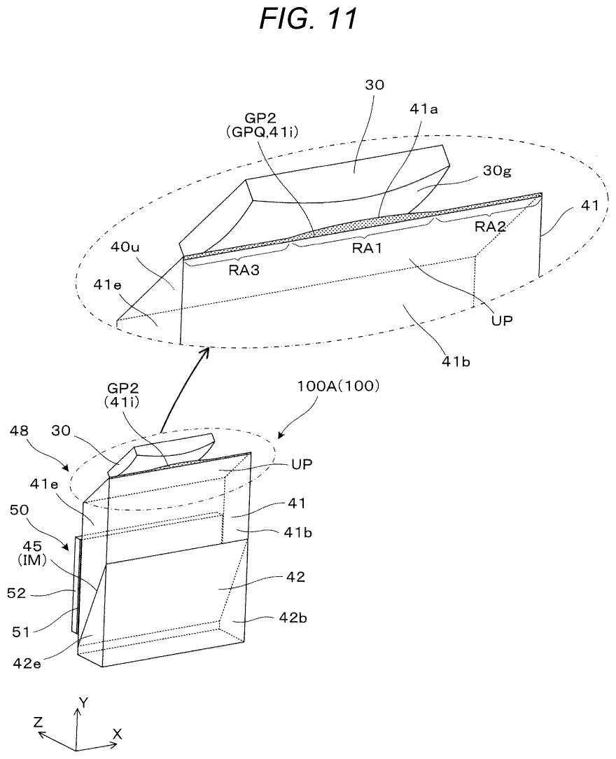

FIG. 11 is a perspective view illustrating the first virtual image display apparatus 100A or the optical unit 100 according to the second embodiment. In the case of the present embodiment, the ghost prevention structure GP2 is formed as a band-shaped region elongated in the lateral X direction in the upper portion UP of the first prism 41, more specifically, in an upper end region of the first inner side surface 41b of the first prism 41. Specifically, the ghost prevention structure GP2 is a light absorption layer 41i, and the light absorption layer 41i is a black matte coating used for optical applications. The ghost prevention structure GP includes a central portion RA1, a right portion RA2, and a left portion RA3. The central portion RA1 is adjacent to the optical plane of incidence 41a and changes in width in the longitudinal direction. The right portion RA2 and the left portion RA3 are adjacent to the upper planar surface 40u and do not change in width in the longitudinal direction. Although not illustrated, similarly to FIG. 8, the light absorption layer 41i as the ghost prevention structure GP1 is formed at the upper planar surface 40u of the first prism 41, and the light absorption layer 41i is also disposed at the first bottom surface 42f of the prism-based light guide member 48.

The ghost prevention structure GP2 in the present embodiment absorbs the unnecessary light GL1 as illustrated in FIG. 5 at the stage of being incident on the upper end of the first inner side surface 41b to thereby limit the passage, and as a result, the observation of the ghost is suppressed.

In the ghost prevention structure GP2, the central portion RA1 has a larger effect of limiting passage of the unnecessary light GL1 to suppress formation of a ghost than compared to the right portion RA2 and the left portion RA3. That is, the ghost prevention structure GP2 may include only the central portion RA1, and even when the right portion RA2 and the left portion RA3 are omitted, the effect of suppressing the ghost is provided.

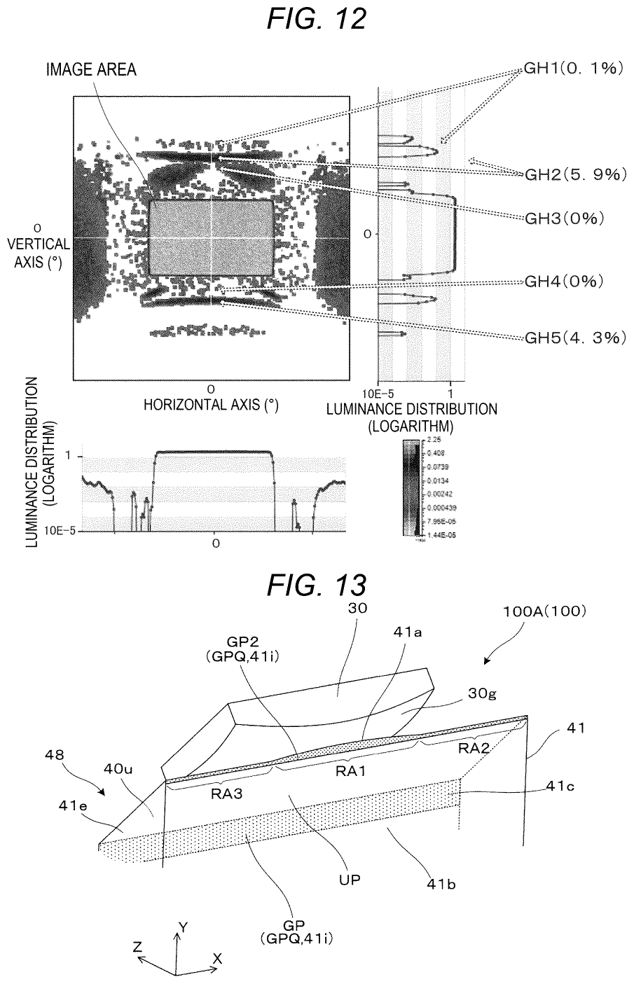

FIG. 12 is a diagram illustrating a projection state of unnecessary light in the virtual image display apparatus of a practical example according to the second embodiment. In the virtual image display apparatus of the practical example, it is understood that the luminance of the third-type ghost GH3, the fourth-type ghost GH4, and the fifth-type ghost GH5 is reduced by the light absorption layer 41i as the ghost prevention structure GP2. The luminance of the third-type ghost GH3 decreases from 7.7% in the comparative example to about 0%. The luminance of the fourth-type ghost GH4 decreases from 0.8% in the comparative example to about 0%. The luminance of the fifth-type ghost GH5 also decreases from 5.9% in the comparative example to about 4.3%.

### Third Embodiment

A virtual image display apparatus and so on according to a third embodiment will hereinafter be described. Note that the virtual image display apparatus of the third embodiment is obtained by partially changing the virtual image display apparatus of the first embodiment.

FIG. 13 is a perspective view illustrating the first virtual image display apparatus 100A or the optical unit 100 according to the third embodiment. In the case of the present embodiment, in the upper portion UP of the first prism 41, the ghost prevention structure GP is disposed at the first outer side surface 41c, and the ghost prevention structure GP2 is disposed at the first inner side surface 41b. The ghost prevention structure GP is the same as the ghost prevention structure GP in the first embodiment shown in FIGS. 2 and 3, and the ghost prevention structure GP2 is the same as the ghost prevention structure GP2 in the second embodiment shown in FIG. 11. Although not illustrated, similarly to FIG. 8, the light absorption layer 41i as the ghost prevention structure GP1 is formed at the upper planar surface 40u of the first prism 41, and the light absorption layer 41i is also disposed at the first bottom surface 42f of the prism-based light guide member 48.

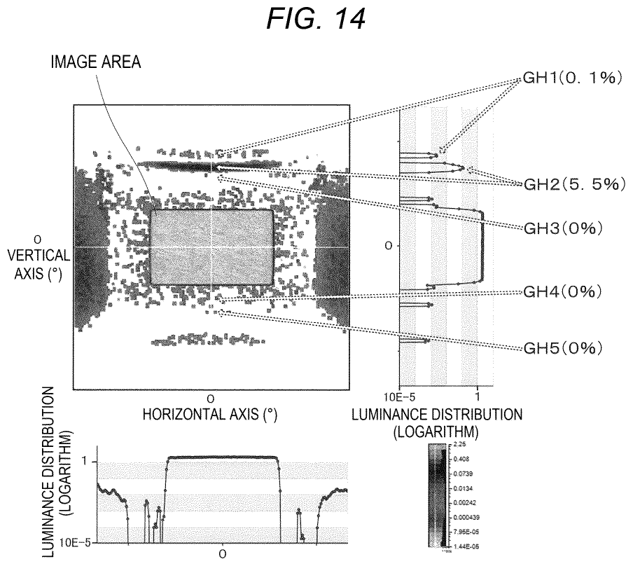

FIG. 14 is a diagram illustrating a projection state of unnecessary light in the virtual image display apparatus of a practical example according to the third embodiment. In the virtual image display apparatus of a practical example, it is understood that the luminance of the third-type ghost GH3, the fourth-type ghost GH4, and the fifth-type ghost GH5 is reduced by the light absorption layers 41i as the ghost prevention structures GP, GP1, and GP2. The luminance of the third-type ghost GH3 decreases from 7.7% in the comparative example to about 0%. The luminance of the fourth-type ghost GH4 decreases from 0.8% in the comparative example to about 0%. The luminance of the fifth-type ghost GH5 also decreases from 5.9% in the comparative example to about 0%.

### Fourth Embodiment

A virtual image display apparatus and so on according to a fourth embodiment will hereinafter be described. Note that the virtual image display apparatus of the fourth embodiment is obtained by partially changing the virtual image display apparatus of the first embodiment or the second embodiment.

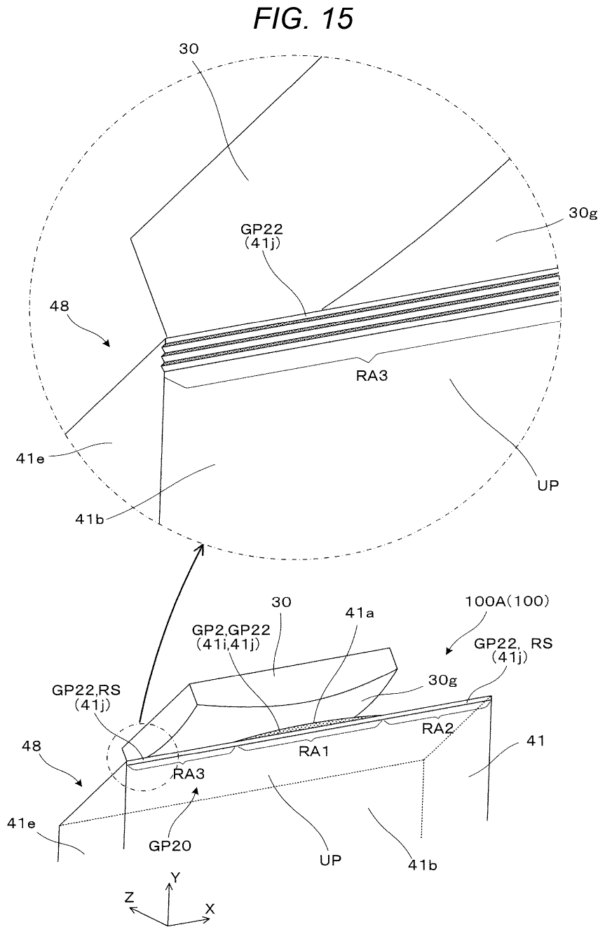

FIG. 15 is a perspective view illustrating the first virtual image display apparatus 100A or the optical unit 100 according to the fourth embodiment. In the first virtual image display apparatus 100A, a refractive ghost prevention structure GP22 is provided as the ghost prevention structure GP20 associated with the first inner side surface 41b in the upper portion UP of the first prism 41. The refractive ghost prevention structure GP22 prevents the unintended image light ML from being guided by the prism-based light guide member 48 in the direct projection-type first virtual image display apparatus 100A.

The refractive ghost prevention structure GP22 is an optical film or an optical element that shifts the image light ML by refraction, and is a refractive element RS. The refractive element RS is, for example, a Fresnel refractive surface 41j, and emits the image light ML to the outside of the prism-based light guide member 48 while diverging or scattering the image light ML by a large number of minute strip-shaped refractive surfaces. Note that the Fresnel refractive surface 41j or the light absorption layer 41i may be provided in a region corresponding to the lens portion 44 in the central portion RA1 in the ghost prevention structure GP22, but may be omitted.

The Fresnel refractive surface 41j can be formed in a lump when molding the first prism 41, but may be formed by attaching a sheet-like member having a Fresnel surface on the first inner side surface 41b. Instead of the Fresnel refractive surface 41j, what is formed of a continuous curved surface may be used as the refractive element RS.

### Fifth Embodiment

A virtual image display apparatus and so on according to a fifth embodiment will hereinafter be described. Note that the virtual image display apparatus of the fifth embodiment is obtained by partially changing the virtual image display apparatus of the first embodiment or the fourth embodiment.

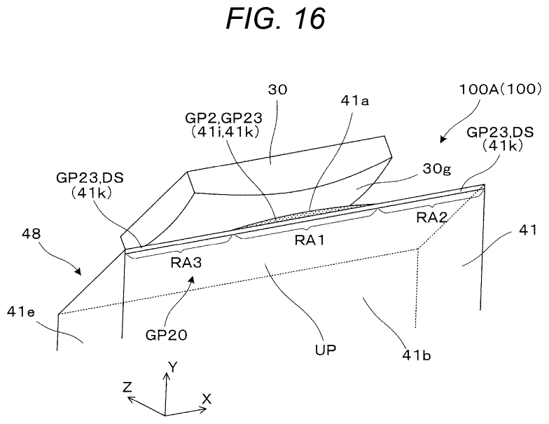

FIG. 16 is a perspective view illustrating the first virtual image display apparatus 100A or the optical unit 100 according to the fifth embodiment. In the first virtual image display apparatus 100A, a diffraction ghost prevention structure GP23 is provided as the ghost prevention structure GP20 associated with the first inner side surface 41b in the upper portion UP of the first prism 41. The diffraction ghost prevention structure GP23 prevents the unintended image light ML from being guided by the prism-based light guide member 48 in the direct projection-type first virtual image display apparatus 100A. The diffraction ghost prevention structure GP23 is an optical film or an optical element that shifts the image light ML with a fine step that gives a phase difference, and is the diffraction element DS. The diffraction element DS is, for example, a blazed diffraction grating 41k, and emits the image light ML to the outside of the prism-based light guide member 48 while diverging or scattering the image light ML by diffraction. Note that in the central portion RA1 of the ghost prevention structure GP23, the blazed diffraction grating 41k or the light absorption layer 41i may be provided in a region corresponding to the lens portion 44, but may be omitted. The diffraction element DS is formed by, for example, nanoimprinting. The diffraction element DS may be formed of a volume hologram or may be formed of a structure such as a meta-lens.

The ghost prevention structure GP is not limited to the diffraction element DS, and may be something like a random scattering surface after performing grinding processing.

### Modified Examples and Others

The present disclosure has been described above with reference to the embodiments, but is not limited to the embodiments described above, and can be implemented in various forms without departing from the gist of the present disclosure. For example, the following modifications are conceivable.

In the above description, the HMD 200 includes the first virtual image display apparatus 100A and the second virtual image display apparatus 100B, but the HMD 200 may support the single first virtual image display apparatus 100A or second virtual image display apparatus 100B in front of the eyes with the aid of the support devices 100C.

In the cover member 52, the compensation flat plate 55 can be omitted. In this case, the quarter-wave plate 51 is disposed only over the range of the second lens 53, and the second lens 53 is covered with the compensation lens 54.

In the second flat-plate member 50, the cover member 52 may be omitted. In this case, the transmissive mirror 56 can be replaced with a mirror without a transmissive property.

The boundary between first inner side surface 41b and the upper planar surface 40u of first prism 41 is not limited to a precise edge shape, and may be slightly rounded. In this case, the ghost prevention structure GP2 can be formed on the rounded surface.

The first lens 30 of the first prism 41 is not essential and can be omitted. In the first prism 41 of the first flat-plate member 40, the optical plane of incidence 41a may be omitted. In this case, the lens portion 44 is omitted from the optical system.

The first lens 30 is not necessarily bonded to the first image forming element 11a, and may be disposed separately from the first image forming element 11a.

The second lens 53 is not limited to a planoconvex lens having positive power, and can be replaced with a diffraction lens, a hologram lens, a liquid crystal lens, or the like having positive power. In this case, the compensation lens 54 can be, for example, a diffraction lens, a hologram lens, or the like having an inverted shape. On this occasion, an optical element itself such as a diffraction lens, a hologram lens, or a liquid crystal lens as the second lens 53 can be provided with a function of partially reflecting the image light ML, but a planar transmissive mirror may be disposed at the external side of such an optical element.

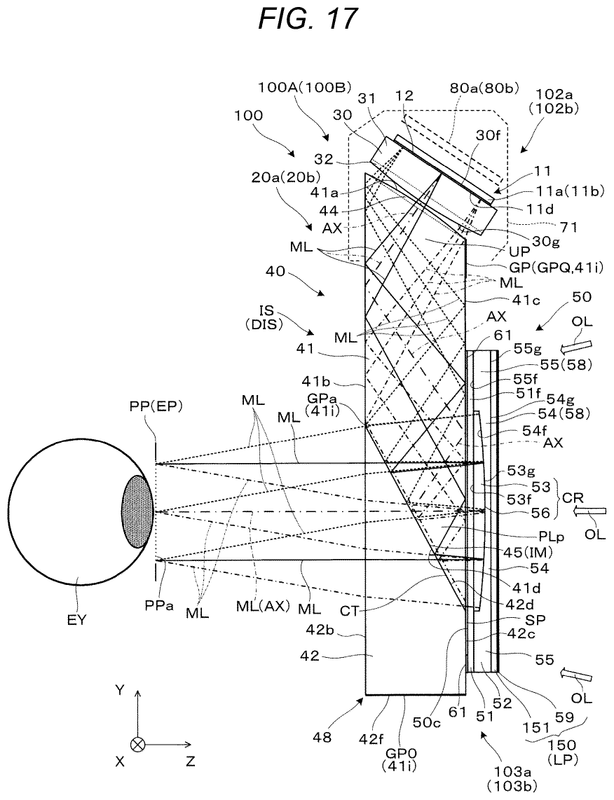

As illustrated in FIG. 17, in the first virtual image display apparatus 100A, for example, the s-polarized light transmissive polarizing plate 12 may be disposed between the first lens 30 and the display element 11 in the first display unit 20a. Furthermore, in the first display unit 20a, a third flat-plate member 150 is added at the external side of the second flat-plate member 50. The third flat-plate member 150 is an image light blocking portion LP. The third flat-plate member 150 includes an outer quarter-wave plate 151 disposed at the external side of the transmissive mirror 56 or the light collecting reflector CR, and a polarizing plate 59 disposed at the external side of the outer quarter-wave plate 151. That is, the first display unit 20a has a structure in which the inner quarter-wave plate 51 and the outer quarter-wave plate 151 are disposed between the inner polarization separation film 45 and the outer polarizing plate 59. The polarizing plate 59 selectively absorbs the image light ML having passed through the outer quarter-wave plate 151 in accordance with the polarization direction of the image light ML.

The circularly polarized image light ML transmitted through the transmissive mirror 56 becomes p-polarized light by passing through the outer quarter-wave plate 151, enters the polarizing plate 59, and is mostly blocked by the polarizing plate 59. That is, the image light ML is blocked by the third flat-plate member 150 and does not leak to the outside. Thus, since the image light ML is prevented from being observed from the outside, the privacy can be ensured. In contrast, the external light OL having entered the polarizing plate 59 becomes only the s-polarized light after passing through the polarizing plate 59, and becomes the circularly polarized light after passing through the outer quarter-wave plate 151, and is partially transmitted through the transmissive mirror 56. The external light OL as the circularly polarized light having been partially transmitted through the transmissive mirror 56 becomes the p-polarized light after passing through the inner quarter-wave plate 51, and is then transmitted through the polarization separation film 45, and is incident on the pupil position PP.

A virtual image display apparatus according to a specific aspect includes a display element configured to emit image light, a first prism on which the image light from the display element is incident, a second prism joined to the first prism to constitute a prism-based light guide member having a parallel plate shape, an inclined mirror portion disposed at a joining portion between the first prism and the second prism and configured to reflect at least a part of the image light guided in the first prism, a lens having positive power and disposed so as to face an outer side surface of the first prism on which the image light reflected by the inclined mirror portion is incident, and a transmissive mirror formed at an external side of the lens and configured to partially reflect, toward the inclined mirror portion, the image light reflected by the inclined mirror portion, wherein the first prism has, at one of the outer side surface and an inner side surface facing the outer side surface in an upper portion, a ghost prevention structure configured to suppress propagation of the image light.

In the virtual image display apparatus described above, since the first prism has the ghost prevention structure that suppresses the propagation of the image light at one of the outer side surface and the inner side surface in the upper portion, even when an unintended component of the image light is incident on the upper portion of the first prism, the passage of the component is limited by the ghost prevention structure, and it is possible to prevent the ghost from being observed in the periphery or the like of the virtual image which is the observation target.

In the virtual image display apparatus in a specific aspect, the ghost prevention structure is disposed at the inner side surface of an upper end of the first prism. The inner side surface of the upper end of the first prism is one of the main causes of the ghost formed around the virtual image as the observation target, and by disposing the ghost prevention structure here, the ghost suppression effect can be enhanced.

In the virtual image display apparatus in a specific aspect, the ghost prevention structure is disposed at the outer side surface of the upper end of the first prism. The outer side surface of the upper end of the first prism is one of the causes of the ghost formed around the virtual image as the observation target, and by disposing the ghost prevention structure here, the ghost suppression effect can be enhanced.

In the virtual image display apparatus in a specific aspect, the ghost prevention structure is disposed at both the inner side surface and the outer side surface of the upper end of the first prism.

In the virtual image display apparatus in a specific aspect, the ghost prevention structure is disposed in a peripheral region of a plane of incidence of the first prism. The peripheral region of the plane of incidence of the first prism is a portion on which unintended image light out of the image light emitted from the display element is incident, and by preventing such unintended image light from passing therethrough, the occurrence of the ghost can further be reduced.

In the virtual image display apparatus in a specific aspect, the ghost prevention structure is a light absorption-type ghost prevention structure formed of a light absorption layer. The light absorption layer blocks unintended image light by absorption.

In the virtual image display apparatus according to a specific aspect, the ghost prevention structure is an optical film or an optical element configured to deviate the image light in passage of the image light. Here, the term deviate means shifting a course of the image light from the normal optical path of the image light such as transmission, refraction, and reflection.

In the virtual image display apparatus according to a specific aspect, the ghost prevention structure is a refraction element configured to deviate the image light by refraction. The refraction structure is, for example, a Fresnel lens, and can divert unintended image light from an optical path leading to the pupil.

In the virtual image display apparatus according to a specific aspect, the ghost prevention structure is a diffraction element configured to deviate the image light by diffraction. The diffraction structure can divert unintended image light from the optical path leading to the pupil.

In the virtual image display apparatus according to the specific aspect, there is further provided a quarter-wave plate disposed between the outer side surface of the first prism and a planar surface of a lens, wherein the inclined mirror portion includes a polarization separation film configured to selectively reflect the image light in accordance with a polarization direction of the image light. In this case, the image light from the first prism is efficiently reflected by the polarization separation film, travels back and forth through the quarter-wave plate when being reflected by the transmissive mirror, and is transmitted through the polarization separation film with a small loss.

A direct optical unit according to a specific aspect includes a display element configured to emit image light, a first prism on which the image light from the display element is incident, a second prism joined to the first prism to constitute a prism-based light guide member having a parallel plate shape, an inclined mirror portion disposed at a joining portion between the first prism and the second prism and configured to reflect at least a part of the image light guided in the first prism, a lens having positive power and disposed so as to face an outer side surface of the first prism on which the image light reflected by the inclined mirror portion is incident, and a transmissive mirror formed at an external side of the lens and configured to partially reflect, toward the inclined mirror portion, the image light reflected by the inclined mirror portion, wherein the first prism has, at one of the outer side surface and an inner side surface facing the outer side surface in an upper portion, a ghost prevention structure configured to suppress propagation of the image light.

What is claimed is:

1. A virtual image display apparatus, comprising:
a display element configured to emit image light;
a first prism on which the image light from the display element is incident;
a second prism joined to the first prism to constitute a prism-based light guide member having a parallel plate shape;
an inclined mirror portion disposed at a joining portion between the first prism and the second prism and configured to reflect at least a part of the image light guided in the first prism;
a lens having positive power and disposed so as to face an outer side surface of the first prism on which the image light reflected by the inclined mirror portion is incident; and
a transmissive mirror formed at an external side of the lens and configured to partially reflect, toward the inclined mirror portion, the image light reflected by the inclined mirror portion, wherein
the first prism has a ghost prevention structure configured to suppress propagation of the image light, and
the ghost prevention structure is disposed at at least one of the outer side surface and an inner side surface facing the outer side surface, in an upper portion of the first prism.

2. The virtual image display apparatus according to claim 1, wherein
the ghost prevention structure is disposed at the inner side surface of an upper end of the first prism.

3. The virtual image display apparatus according to claim 1, wherein
the ghost prevention structure is disposed at the outer side surface of an upper end of the first prism.

4. The virtual image display apparatus according to claim 2, wherein
the ghost prevention structure is disposed at both the inner side surface and the outer side surface of the upper end of the first prism.

5. The virtual image display apparatus according to claim 1, wherein
the ghost prevention structure is disposed in a peripheral region of a plane of incidence of the first prism.

6. The virtual image display apparatus according to claim 1, wherein
the ghost prevention structure is a light absorption-type ghost prevention structure formed of a light absorption layer.

7. The virtual image display apparatus according to claim 1, wherein
the ghost prevention structure is an optical film or an optical element configured to deviate the image light in passage of the image light.

8. The virtual image display apparatus according to claim 7, wherein
the ghost prevention structure is a refraction element configured to deviate the image light by refraction.

9. The virtual image display apparatus according to claim 7, wherein
the ghost prevention structure is a diffraction element configured to deviate the image light by diffraction.

10. The virtual image display apparatus according to claim 1, further comprising:
a quarter-wave plate disposed between the outer side surface of the first prism and a planar surface of a lens, wherein
the inclined mirror portion includes a polarization separation film configured to selectively reflect the image light in accordance with a polarization direction of the image light.

11. An optical unit, comprising:
a display element configured to emit image light;
a first prism on which the image light from the display element is incident;
a second prism joined to the first prism to constitute a prism-based light guide member having a parallel plate shape;
an inclined mirror portion disposed at a joining portion between the first prism and the second prism and configured to reflect at least a part of the image light guided in the first prism;
a lens having positive power and disposed so as to face an outer side surface of the first prism on which the image light reflected by the inclined mirror portion is incident; and
a transmissive mirror formed at an external side of the lens and configured to partially reflect, toward the inclined mirror portion, the image light reflected by the inclined mirror portion, wherein
the first prism has, at one of the outer side surface and an inner side surface facing the outer side surface in an upper portion, a ghost prevention structure configured to suppress propagation of the image light.
